(19) United States
(12) Patent Application Publication
(10) Pub. No.: US 2017/0329308 A1
(43) Pub. Date: Nov. 16, 2017

(54) METHOD OF PROCESSING AND STORING CONTROL PROCESS PARAMETERS OF A 3D PRINTER

(71) Applicant: ZORTRAX SPÓLKA AKCYJNA, Olsztyn (PL)

(72) Inventor: Rafal TOMASIAK, Olsztyn (PL)

(21) Appl. No.: 15/533,765

(22) PCT Filed: Mar. 30, 2015
(86) PCT No.: PCT/PL2015/000056

§ 371 Date: Jun. 7, 2017

(30) Foreign Application Priority Data
Dec. 22, 2014 (PL) P.410736

(51) Int. Cl. G05B 19/4099; B33Y 50/02; B29C 64/393

(52) U.S. Cl. CPC G05B 19/4099; B29C 64/393; B33Y 50/02; G05B 2219/49023; G05B 2219/35134

(57) ABSTRACT

A method of processing and storing control process parameters of a 3D printer is disclosed. The processed data are converted into a binary file located in the PC, and then the contents of a binary file is transferred to the printer data memory. The printer controller performs the execution of the program contained in the read-only memory of the printer controller by generating signals for printer actuators based on the numbers, in the integer form, downloaded from the data memory.

The present invention relates to a method of processing and storing control process parameters of a 3D printer.

The classic method of processing and storing of control process parameters of a 3D printer is executed in the following steps. Development of the shape of the object in a descriptive form or as graphic program (e.g. AutoCAD, Solid Works) documentation. Preparation of the text file that contains commands for the printer actuators, so-called G-code. Preparation of G-code is carried out by manual editing on the description basis or may be automatically generated, based on the files obtained from the graphic programs. Transferring a G-code text file to the printer memory.

Transfer of the parameters and instructions contained in the G-code by means of an internal command interpreter, execution of relevant parts of the controller program, which transmits signals to actuators.

The use of interpreter and text record of commands and parameters in information processing on 3D printer actuators requires high computing power and large memory capacity of the printer control unit as well as slows down the process of communication between 3D printer and personal computer, acting as a user interface.

Computing power of PC and the lack of strict time regimes during processing of information predisposes them to take over or change the execution method of some of the tasks currently performed by the printer controller. An example of excessive load of the printer controller is the necessity of interpretation of the position text recording to the form of floating point, and then to the integer format appropriate for stepping motor control.

According to the invention the characteristics of a method of processing and storing control process parameters of 3D printer is that the data processed in a descriptive form, using G-code, or as a graphics (e.g. AutoCAD, Solid Works) program file are converted to binary file and stored in a PC, then the contents of a binary file is sent to the data memory of the printer controller. The printer controller performs the execution of the program contained in the read-only memory (ROM) of the printer controller by generating signals for the actuators based on the numbers, in integer form, downloaded from the data memory.

The method of processing and storing control process parameters of 3D printer according to the invention reduces the requirements for computing power and memory capacity of the printer controller in comparison with the existing solutions the 3D printer control system. Converting data to a binary file in a PC shortens the time of data transmission via personal computer-printer interface.

The invention will be illustrated in the embodiments on drawings.

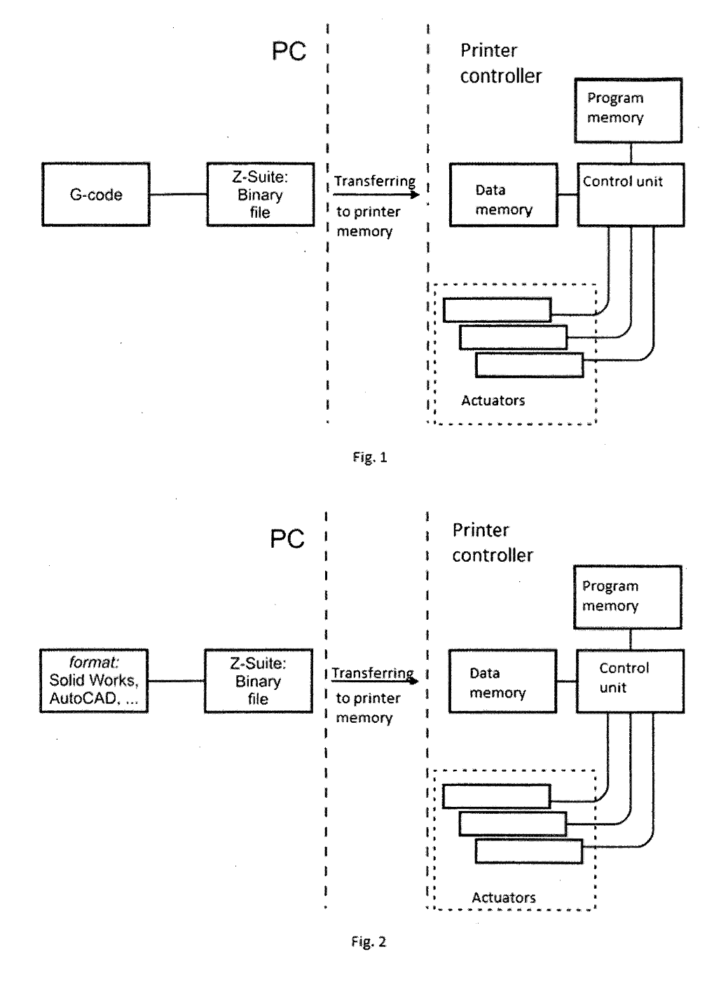

FIG. 1 shows the method of processing and storing control process parameters of a 3D printer using G-code and FIG. 2 shows the method of processing and storing control process parameters of a 3D printer using the AutoCAD graphics program.

### EXAMPLE 1

A method of processing and storing the 3D printer control process parameters is to develop a 3D shape of an object as a text file 1 in G-code and then transfer the processed data to a binary file 2 located in the PC. The contents of a binary file 2 is then converted to the data memory 3 of the printer and the printer controller 4 performs the execution of the program contained in the read-only memory 5 (ROM) of the printer controller 4 by generating signals for printer actuators 6 based on the numbers, in the integer form, downloaded from the data memory 7.

### EXAMPLE 2

A method of processing and recording the 3D printer control process parameters is to develop a shape of an object as a AutoCAD graphics program file 8, then the processed data are sent to a binary file 2 located in the PC. The contents of a binary file 2 is converted to the data memory of the printer 3 and then the printer controller 4 performs the execution of the program contained in the read-only memory 5 (ROM) of the printer controller 4 by generating signals for printer actuators 6 based on the numbers, in the integer form, downloaded from the data memory 7.

1. A method of processing and storing control process parameters of a 3D printer comprising the development of an object shape in the form of graphics programs or development and storing a text file in G-code and delivering the processed data to the printer controller memory, wherein the processed data are converted into a binary file located in the PC, then the contents of a binary file is transferred to the printer data memory; the printer controller performs the execution of the program contained in the read-only memory of the printer controller by generating signals for printer actuators based on the numbers, in the integer form, downloaded from the data memory.
